(19) United States
(12) Patent Application Publication
(10) Pub. No.: US 2009/0268754 A1
(43) Pub. Date: Oct. 29, 2009

(54) METHODS, DEVICES, AND COMPUTER PROGRAM PRODUCTS FOR REMOTELY CONTROLLING OPERATIONS OF DIGITAL MEDIA DEVICES USING A MOBILE TERMINAL

(75) Inventors: Nils Erik Ola Palm, Lund (SE); Krister Erik Tham, Lund (SE); Anders Hansson, Klagerup (SE); Lars Niklas Larsson, Malmo (SE); John Gunnar Andreas Munchmeyer, Rydeback (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communication AB

(21) Appl. No.: 12/110,858

(22) Filed: Apr. 28, 2008

(51) Int. Cl. H04J 3/22

(52) U.S. Cl. 370/466

(57) ABSTRACT

A method of controlling operations of a plurality of digital media devices on a network that are configured to communicate using a first communications protocol includes establishing a wireless connection between a mobile terminal and a digital media control point device. The digital media control point device is configured to communicate with the plurality of digital media devices via the network using the first communications protocol. A command to control an operation of at least one of the plurality of digital media devices is transmitted from the mobile terminal and is received at the digital media control point device via the wireless connection using a second communications protocol that is different from the first communications protocol. The received command is correlated to a corresponding command in accordance with the first communications protocol, and is transmitted to the at least one of the plurality of digital media devices via the network using the first communications protocol. Data from the at least one of the plurality of digital media devices is received at the digital media control point device via the network using the first communications protocol, and at least a portion of the data is transmitted to the mobile terminal via the wireless connection using the second communications protocol. Related devices and computer program products are also discussed.

### FIELD OF THE INVENTION

The present invention relates to communication networks, and more particularly, to providing interoperability for electronic devices via communication networks.

### BACKGROUND OF THE INVENTION

Electronic devices, such as televisions, personal computers, and mobile terminals, increasingly provide access to a variety of communications, multimedia, and/or data processing capabilities. For example, Digital Living Network Alliance (DLNA)-compliant digital media devices are becoming more and more common in many homes. DLNA-compliant digital media devices may be configured to store, render, and/or otherwise provide access to digital media content, such as audio, video, and/or image files, in accordance with open industry standards specified by the DLNA. Such devices are typically connected on a local network, and may be configured to communicate using standardized protocols, such as the Universal Plug-and-Play (UPnP) protocol. In particular, the DLNA standard may represent the higher level content negotiation and sharing portion of the broader UPnP standard, which may deal with the lower level intercommunications between disparate networked devices.

The DLNA Interoperability Guidelines may specify that all DLNA-compliant devices have an Ethernet, Wi-Fi, or Bluetooth network interface, use TCP/IP for networking, and implement HTML and SOAP for media transport and management. Media Formats may also be specified. For example, JPEG, LPCM, and MPEG2 support may be specified for image, audio, and video devices respectively. A typical DLNA-complaint home setup may include a digital media server (DMS), a digital media renderer (DMR), and a digital media control point (DMC). The DMC, DMS, and DMR may be configured to communicate with one another using the UPnP protocol via a network. The DMS may be configured to store digital multimedia content, such as audio, video, and/or image files. The DMR may be configured to render or playback the digital multimedia data on an output device, such as a stereo or television. The DMC may be configured to coordinate and/or control operations of the DMS and/or DMR. For example, the DMC may browse the DMS to find available digital audio, video, and/or image content, and may display a listing of the available content on its graphical user interface (GUI). In response to receiving a selection of the available content from a user, the DMC may transmit a command to the DMR indicating the user's selection. The DMR may thereby fetch the indicated media from the DMS (for example, as a continuous stream), and the media may be rendered on a stereo or monitor connected to the output of the DMR. Accordingly, a network including DLNA-compliant media devices may provide a seamless environment for sharing digital media content and/or services.

### SUMMARY OF THE INVENTION

According to some embodiments of the present invention, a method of controlling operations of a plurality of digital media devices on a network that are configured to communicate using a first communications protocol includes establishing a wireless connection between a mobile terminal and a digital media control point device. The digital media control point device is configured to communicate with the plurality of digital media devices via the network using the first communications protocol. A command to control an operation of at least one of the plurality of digital media devices is transmitted from the mobile terminal to the digital media control point device via the wireless connection using a second communications protocol that is different from the first communications protocol.

In some embodiments, the mobile terminal may not be configured for communication using the first communications protocol.

In other embodiments, the first and second communications protocols may correspond to a same layer of an Open Systems Interconnection (OSI) model. The second communications protocol may include a reduced set of commands in comparison to that of the first communications protocol.

In some embodiments, wireless communication between the mobile terminal and the digital media control point device may be established using an application program interface (API) based on the second communications protocol. The second communications protocol may include commands that correlate to commands defined by the first communications protocol.

In other embodiments, the first communications protocol may be a Digital Living Network Alliance (DLNA)-compliant application layer protocol, and the second communications protocol may be a non-DLNA-compliant application layer protocol.

In some embodiments, data may be received from the digital media control point device via the wireless connection using the second communications protocol in response to transmitting the command.

In other embodiments, the command from the mobile terminal may be received at the digital media control point device via the wireless connection using the second communications protocol. The received command may be correlated to a corresponding command in accordance with the first communications protocol, and the corresponding command may be transmitted to the at least one of the plurality of digital media devices via the network using the first communications protocol.

In some embodiments, data from the at least one of the plurality of digital media devices may be received at the digital media control point device via the network using the first communications protocol in response to transmitting the corresponding command. A portion of the received data may be extracted, and the portion of the received data may be transmitted from the digital media control point device to the mobile terminal via the wireless connection using the second communications protocol in response to receiving the command.

In other embodiments, the plurality of digital media devices may include at least one digital media server (DMS) configured to store digital media content and/or at least one digital media renderer (DMR) configured to render the digital media content on an output device.

According to other embodiments of the present invention, a method for controlling operations of a plurality of digital media devices on a network that are configured to communicate using a first communications protocol includes establishing a wireless connection between a digital media control point device and a mobile terminal. The digital media control point device is configured to communicate with the plurality of digital media devices via the network using the first communications protocol. A command to control an operation of at least one of the plurality of digital media devices is received at the digital media control point device from the mobile terminal via the wireless connection using a second communications protocol that is different from the first communications protocol. The received command is correlated to a corresponding command in accordance with the first communications protocol, and the corresponding command is transmitted to the at least one of the plurality of digital media devices via the network using the first communications protocol.

According to further embodiments of the present invention, a mobile terminal includes a wireless transceiver configured to establish a wireless connection with a digital media control point device. The digital media control point device is configured to communicate with a plurality of digital media devices via a network using a first communications protocol. The mobile terminal further includes a controller configured to transmit a command to control an operation of at least one of the plurality of digital media devices to the digital media control point device via the wireless connection using a second communications protocol that is different from the first communications protocol.

According to still further embodiments of the present invention, a digital media control point device includes a transceiver configured to establish a wireless connection between the digital media control point device and a mobile terminal. The digital media control point device is configured to communicate with a plurality of digital media devices via a network using a first communications protocol. The digital media control point device further includes a processor configured to receive a command to control an operation of at least one of the plurality of digital media devices from the mobile terminal via the wireless connection using a second communications protocol that is different from the first communications protocol. The processor is also configured to correlate the received command to a corresponding command in accordance with the first communications protocol, and transmit the corresponding command to the at least one of the plurality of digital media devices via the network using the first communications protocol.

Although described above primarily with respect to method and device aspects of the present invention, it will be understood that the present invention may be embodied as methods, devices, and/or computer program products.

### BRIEF DESCRIPTION OF THE DRAWINGS

FIG. 1 is a block diagram illustrating a system for controlling operations of a plurality of digital media devices on a network using a mobile terminal according to some embodiments of the present invention.

FIG. 2 is a block diagram illustrating a mobile terminal according to some embodiments of the present invention.

FIG. 3 is a block diagram illustrating a digital media control point (DMC) according to some embodiments of the present invention.

FIGS. 4-6 are flowcharts illustrating example operations for controlling operations of a plurality of digital media devices on a network using a mobile terminal according to some embodiments of the present invention.

### DETAILED DESCRIPTION OF EMBODIMENTS OF THE INVENTION

The present invention now will be described more fully hereinafter with reference to the accompanying drawings, in which illustrated embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. In contrast, when an element is referred to as being “directly coupled” or “directly connected” to another element, there are no intervening elements present. Furthermore, “connected” or “coupled” as used herein may include wirelessly connected or coupled. As used herein, the term “and/or” includes any and all combinations of one or more of the associated listed items, and may be abbreviated as “/”.

It will also be understood that, although the terms first, second, etc. may be used herein to describe various elements, these elements should not be limited by these terms. These terms are only used to distinguish one element from another. For example, a first communications protocol could be termed a second communications protocol, and, similarly, a second communications protocol could be termed a first communications protocol without departing from the teachings of the disclosure.

As will be appreciated by one of skill in the art, the present invention may be embodied as methods, devices, and/or computer program products. Accordingly, the present invention may be embodied in hardware and/or in software (including firmware, resident software, micro-code, etc.). Computer program code for carrying out operations of devices and/or systems discussed herein may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. The program code may execute entirely on a single processor and/or across multiple processors, as a stand-alone software package or as part of another software package. The program code may execute entirely on an electronic device or only partly on the electronic device and partly on another device. In the latter scenario, the other device may be connected to the electronic device through a wired and/or wireless local area network (LAN) and/or wide area network (WAN), or the connection may be made to an external computer (for example, through the Internet using an Internet Service Provider).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

For purposes of illustration, some embodiments of the present invention are described herein in the context of a mobile terminal. As used herein, the term “mobile terminal” or “mobile electronic device” may include conventional cell phones, Personal Communications Systems (PCS)/smart phones that may include data processing, voice, video, text message, e-mail and/or Web access capabilities, Personal Digital Assistants (PDA) with wireless communications capabilities, wireless pagers, Blackberry wireless handheld e-mail devices, radios, and/or other portable electronic devices, but may exclude laptop and/or palmtop computers. Also, “digital media devices” include electronic devices configured to store, render, and/or otherwise provide access to digital media content, such as audio, video, and/or image files.

Some embodiments of the present invention may arise from realization that, while conventional digital media control point devices may communicate short commands to other passive digital media devices on a network according to standards established by the Digital Living Network Alliance (DLNA), they typically do not transmit and/or receive the multimedia data traffic stored on the other passive digital media devices. Accordingly, some embodiments of the present invention provide methods and devices for allowing mobile terminals, such as mobile phones, to provide limited functionality as a digital media control point device. In particular, some embodiments of the present invention enable a mobile terminal to act as a remote control for digital media devices using a proprietary application program interface (API) between the mobile terminal and an external DLNA-compliant digital media control point device. Such mobile terminals offer a user interface (UI) and include sufficient computational power to communicate short commands and/or data to the digital media control point device, and may allow a user to move around in the home without constraint. As such, a non-DLNA compliant mobile terminal may be used to control all DLNA-compliant networked digital media devices in a home.

Some problems addressed by some embodiments of the present invention as discussed in detail below include power consumption (a mobile device implementing full DMC functionality may consume energy even in passive state, since it may constantly communicate with the devices on the network to be aware of changes), processor power (a DMC may require greater computational power due to additional network communications), new software (a mobile device implementing full DMC functionality may require a new network stack), and memory (the added DMC stack may consume a large portion of the limited memory on the mobile device, including RAM and/or flash memory). Accordingly, some embodiments of the present invention provide mobile terminals that are configured to act as resource-efficient remote control points for networked digital media devices.

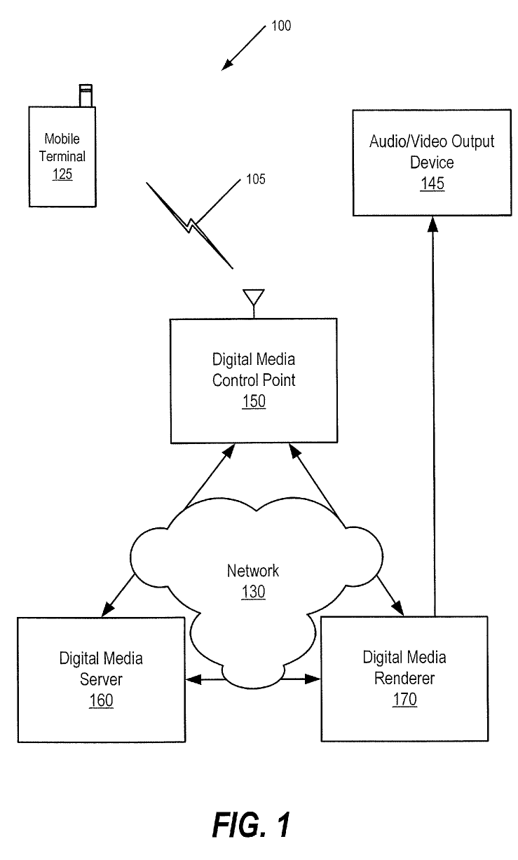

FIG. 1 illustrates a system for controlling operations of a plurality of digital media devices on a network according to some embodiments of the present invention. Referring now to FIG. 1, the system 100 includes a mobile terminal 125, such as a mobile phone, that is configured to communicate with a digital media control point (DMC) 150 via a wireless client-server connection 105. The digital media control point 150 is connected to a digital media server (DMS) 160 and a digital media renderer (DMR) 170 via a network 130. The DMR 170 is connected to an audio/video output device 145. In some embodiments, the network 130 may be a home network, a local area network (LAN), an Intranet, or other private network, which may not be accessible by the general public. However, in other embodiments, the network 130 may represent a wide area network (WAN), a global network, such as the Internet, or other publicly accessible network. The network 130 may utilize multiple wireless and/or wireline access protocols in compliance with the DLNA standard for communication between the network devices 150, 160, and 170. For example, three network connection technologies are incorporated in the DLNA 1.5 Interoperability Guidelines: 10Base-T and 100Base-T Ethernet (802.3i/802.3u) for wired connections, Wi-Fi (802.11a/802.11b/802.11g) for wireless connections, and Bluetooth for wireless connections for mobile handheld devices such as cell phones and PDAs. Although only a single DMS 160 and DMR 170 are shown in FIG. 1 by way of example, it is to be understood that multiple digital media servers and/or multiple digital media renderers may be connected to the DMC 150 via the network 130.

The DMS 160 is a server that is configured to store digital media content, such as audio, video, and/or image data. The DMS 160 is configured to transmit selected media content to other devices on the network 130. Where more than one DMS 160 is present on the network 130, each DMS may have a unique and/or permanent identification, which can be used to select a particular server. The DMR 170 is configured to render the selected digital media content via the output device 145, such as a television, monitor, stereo, and/or other audio/video presentation device. When more than one DMR 170 is present on the network 130, each DMR may likewise have a unique and/or permanent identification that can be used to select a particular renderer. The DMC 150 is configured to coordinate and/or control operations of the DMS 160 and/or DMR 170 via the network 130. While illustrated in FIG. 1 as a stand-alone component, it is to be understood that a DMC 150 according to some embodiments of the present invention may be situated on another device on the network 130, such as a PC, router, and/or access point, or even on the DMS 160 and/or DMR 170.

The DMC 150, the DMS 160, and the DMR 170 are DLNA-compliant devices configured to communicate via the network 130 using a DLNA-compliant communications protocol. For example, the DMC 150, the DMS 160, and the DMR 170 may be configured to communicate using the UPnP AV (Audio and Video) protocol. The DLNA stack on the DMC 150 may be built up by UPnP, and as such, may use protocols including HTTP (Layer 5 of the OSI model), XML, SOAP (Layer 5 of the OSI model), SSDP (Layer 5 of the OSI model), UDP (Layer 4 of the OSI model), TCP (Layer 4 of the OSI model), and/or other protocols above the IP layer (also referred to herein as the network layer, corresponding to Layer 3 of the OSI model). In some embodiments, the DLNA stack may be situated in higher layers, such as Layer 6 (also referred to herein as the presentation layer) and/or Layer 7 (also referred to herein as the application layer) of the OSI model. Accordingly, in particular embodiments of the present invention, the DMC 150, the DMS 160, and the DMR 170 may be configured to communicate using a DLNA-compliant application layer protocol.

In contrast, the mobile terminal 125 is a non-DLNA-compliant device, and thus, is not configured for higher-layer communication using a DLNA-compliant communications protocol. As such, some embodiments of the present invention provide an Application Program Interface (API) configured to provide communication between the non-DLNA-compliant mobile terminal 125 and the DLNA-compliant DMC 150 and/or other devices. The API may be based on a different application-layer communications protocol than that used for application-layer communication between the DMC 150 and the DMS 160 and/or the DMR 170. For example, the API may be based on a proprietary ‘lightweight' application layer communications protocol, which may be better suited for small mobile electronic devices having limited memory, battery life, and/or processor power. In particular, the proprietary protocol may have a reduced set of commands in comparison with DLNA-compliant application layer protocols. The mobile terminal 125 may thereby include a relatively small client application that governs the API and the user interface for communication with the DMC 150, and the DMC 150 may execute the commands received from the mobile terminal 125, as discussed in detail below. As such, the more extensive and resource-consuming higher-layer DLNA-compliant protocols are not implemented on the mobile terminal 125.

Accordingly, the API may be used to establish wireless communication between the mobile terminal 125 and the DMC 150. For example, the API communication may be used over a socket-based interface that specifies a particular network address and a port number for communication with the DMC 150, and both the mobile terminal 125 and the DMC 150 may include a wireless local area network interface transceiver that is configured to establish the wireless connection 105 based on the specified network address and port number. The network address and port number may be found, for example, using a UDP broadcast discovery mechanism. In other embodiments, however, the API may not be socket-based. The wireless local area network interface transceiver may be provided, for instance, according to a Wi-Fi (IEEE 802.11) and/or a Bluetooth standard. In addition, Near Field Communication (NFC) and Bluetooth pairing may be used to establish the wireless connection 105. The mobile terminal 125 and the DMC 150 may also include an infrared (IR) transceiver configured to establish the wireless connection 105 using an infrared coupling. In some embodiments, the wireless connection 105 may be an ad hoc connection that is established directly between the mobile terminal 125 and the DMC 150. However, in other embodiments, the wireless connection 105 may be established over the network 130 via a router and/or access point.

Using the wireless connection 105, the mobile terminal 125 transmits commands to the DMC 150 in accordance with the non-DLNA compliant communications protocol. The commands specify control of operations of one or more of the DLNA-compliant media devices 160 and 170 on the network 130. For example, the commands may be short commands provided according to a proprietary communications protocol to browse the available digital media content on one or more digital media servers 160 on the network, to select one(s) of the available digital media content for playback, and/or to select a particular digital media renderer 170 and/or an output device 145 connected thereto for playback. The commands may further include specific commands to control operation of the selected renderer 170 and/or output device 145, such as play, stop, pause, rewind, fast forward, skip forward, skip backward, set volume, get current DMR status, get events (from the current selected DMS and/or DMR), ask if DMR can play specific content, configure DMR (e.g., resolution, audio quality, equalizer mode, etc.), and/or other short commands. The DMC 150 executes the commands received from the mobile terminal 125 via the wireless connection 105 using its protocol stack. More particularly, the DMC 150 converts or correlates the received non-DLNA compliant commands to corresponding commands in accordance with the DLNA-complaint protocol used for communication with the other digital media devices on the network 130, and transmits the corresponding commands to the specified one(s) of the digital media devices on the network 130 using the DLNA-compliant protocol. As such, the mobile terminal 125 may forward relatively short commands to the DMC 150 via the wireless connection 105 using a proprietary and/or otherwise non-DLNA compliant protocol, rather than implementing the relatively large DLNA protocol stack on the mobile terminal 125.

For example, the DMC 150 may receive a command from the mobile terminal 125 in accordance with a non-DLNA compliant protocol via the wireless connection 105 to browse the available digital media content on the DMS 160. In response to the received command, the DMC 150 may transmit a corresponding command to the DMS 160 via the network 130 using the DLNA-compliant protocol, and in response, may receive data from the DMS 160 listing the available digital media stored on the DMS 160 using the DLNA-compliant protocol. The DMS 150 may then transmit the received data (or a portion thereof) to the mobile terminal 125 via the wireless connection 105 using the non-DLNA compliant protocol in response to receiving the command from the mobile terminal 125, and the mobile terminal 125 may display a listing of the digital media content available on the DMS 160. If the DMC 150 fails to receive the requested data from the DMS 160, the DMC 150 may reply to the mobile terminal 125 with an error code (stating the type of failure) and/or additional data (such as a list of other available servers) in accordance with the non-DLNA compliant protocol.

In some embodiments, the DMC 150 may be configured to aggregate network information and forward only necessary data to the mobile terminal 125 using the non-DLNA compliant protocol to improve resource efficiency. For example, the DMC 150 may pare-down and/or extract portions of the data received from the DMS 160 for transmission to the mobile terminal 125 to comply with the power, processing, and/or memory constraints of the mobile terminal 125. In particular, in the above example, the DMC 150 may extract metadata that indicates the available digital media content stored in the DMS 160, and may transmit only the metadata to the mobile terminal 125 in response to receiving the browse command. Also, the DMC 150 may be configured to transmit up-to-date state data to the mobile terminal 125 only in response to receiving a command and/or request therefrom, rather than constantly forwarding status and/or other information received from the network devices 160 and/or 170. Thus, as data may only be received at the mobile terminal 125 in response to transmission of a request and/or command, power consumption of the mobile terminal 125 may be reduced.

Accordingly, some embodiments of the present invention as illustrated by the system 100 of FIG. 1 allow a client application on a non-DLNA compliant mobile terminal 125 to connect to a DMC 150 using a proprietary socket-based API. The mobile terminal 125 can then act as a remote control point for the digital media devices 150, 160, and/or 170, even though the DMC stack is not implemented on the mobile terminal 125. Such a solution may be transparent for a user of the mobile terminal 125, as the user may control the media servers and/or renderers on the network by sending specific commands initiated by the user, with benefits including relatively short response times and/or low power consumption.

Although FIG. 1 illustrates exemplary systems for controlling digital media devices using a mobile terminal according to some embodiments of the present invention, it will be understood that the present invention is not limited to such configurations. For example, although illustrated as separate elements in FIG. 1, it is to be understood that some or all of the functionality of the DMC 150 can be implemented in another device on the network 130, such as the DMR 170, the DMS 160, a PC, and/or a router/access point. Likewise, the functionality of the DMS 160 and/or the DMR 170 can be implemented in other devices on the network 130. Also, although the wireless connection 105 is illustrated as a direct or ad hoc connection and the connections between the digital media devices 150, 160, and 170 are illustrated as network connections, it is to be understood that the wireless connection 105 between the mobile terminal 125 and the DMC 150 may be established via a network, and that the connections between the DMC 150, DMS 160, and/or the DMR 170 may be established directly in some embodiments.

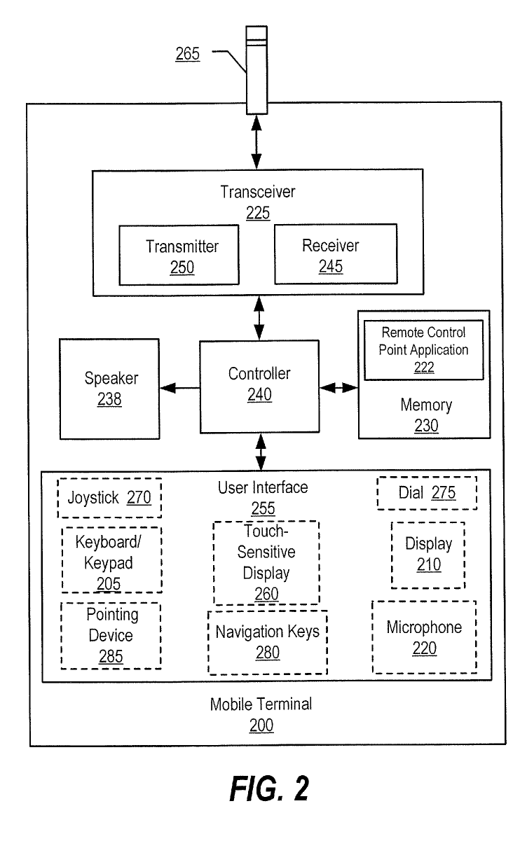

FIG. 2 is a block diagram illustrating a mobile terminal 200 and related methods of operation according to some embodiments of the present invention. In some embodiments, the mobile terminal 200 may correspond to the mobile terminal 125 of FIG. 1. As shown in FIG. 2, the mobile terminal 200 includes a wireless transceiver 225, an antenna 265, a controller 240, a memory 230, a speaker 238 and a user interface 255. Depending on the functionalities offered by the mobile terminal 200, the user interface 255 may include a microphone 220, a display 210 (such as a liquid crystal display), a joystick 270, a keypad 205, a touch sensitive display 260, a dial 275, navigation/directional keys 280, and/or a pointing device 285 (such as a mouse, track ball, touch pad, etc.). However, additional and/or fewer elements of the user interface 255 may actually be provided. For example, the touch sensitive display 260 may be provided in a personal digital assistant (PDA) that does not include a display 210, a keypad 205, and/or a pointing device 285.

The transceiver 225 may include a transmitter circuit 250 and a receiver circuit 245, which respectively transmit outgoing radio frequency signals and receive incoming radio frequency signals via the antenna 265. The radio frequency signals may include both traffic and control signals (e.g., paging signals/messages for incoming calls), which may be used to establish and maintain communication with another party or destination. The transceiver 225 further includes a wireless local area network interface transceiver configured to establish a wireless client-server connection, such as an ad hoc wireless connection, with a digital media device, such as the digital media control point (DMC) 150 of FIG. 1, via the antenna 265. As used herein, an “ad hoc wireless connection” refers to a direct connection between two devices that may be established for the duration of one session and may require no base station. The transceiver 225 is configured to establish such an ad hoc wireless connection according to a localized wireless connection protocol, such as a Bluetooth, Wi-Fi, and/or IR connection protocol. However, the transceiver 225 may also be configured to establish a wireless client-server connection with a digital media device over a network, such as the network 130 of FIG. 1, via a router and/or access point in some embodiments.

The controller 240 is coupled to the transceiver 225, the memory 230, the speaker 238, and the user interface 255. The controller 240 may be, for example, a commercially available or custom microprocessor configured to coordinate and manage operations of the transceiver 225, the memory 230, the speaker 238, and/or the user interface 255. The memory 230 may represent a hierarchy of memory that may include volatile and/or nonvolatile memory, such as removable flash, magnetic, and/or optical rewritable nonvolatile memory. The memory 230 may be configured to store several categories of software, such as an operating system, application programs, and input/output (I/O) device drivers. The operating system controls the management and/or operation of mobile terminal resources, and may coordinate execution of programs by the controller 240. The I/O device drivers typically include software routines accessed through the operating system by the application programs to communicate with input/output devices. The application programs implement various features according to embodiments of the present invention, and preferably include at least one remote control point application 222 which supports operations for establishing a wireless connection and communicating with a digital media control point (DMC) via the transceiver 225, as well as operations for providing a graphical user interface (GUI) used to remotely control digital media devices on a network.

More particularly, still referring to FIG. 2, the remote control point application 222 is configured to provide the graphical user interface (GUI) and to generate commands for transmission to the DMC as defined by an application program interface (API) configured to provide communication between the non-DLNA-compliant mobile terminal 200 and the DLNA-compliant DMC and/or other digital media device. The API is based on a different communications protocol than those specified by the DLNA standard. For example, the API may be a socket-based, command-driven interface that is based on a proprietary communications protocol, which may be better suited for the limited memory and/or battery life of the mobile terminal 200. The proprietary protocol may have a reduced set of commands in comparison with the DLNA-compliant protocols used for communication between the DMC and the other digital media devices on the network at the same OSI layer. For example, the reduced set of commands may include short commands to find servers and/or renderers in the network, to select and browse the available media content of a particular server, to select a renderer for playback, and/or to control the playback by the renderer. Such short commands may include, for example, play, stop, pause, rewind, fast forward, skip forward, skip backward, set volume, get current DMR status, get events (from the current selected DMS and/or DMR), ask if DMR can play specific content, configure DMR (e.g., resolution, audio quality, equalizer mode, etc.), and/or other short commands. Thus, in response to receiving user selections via the GUI, the remote control point application 222 is configured to generate and transmit commands as specified by the API for execution by the DMC to control particular functions of the DLNA-compliant digital media devices. As such, the more extensive and resource-consuming DLNA-compliant protocols are not implemented on the mobile terminal 200.

In some embodiments, the remote control point application 222 including the networking socket API and the GUI may be implemented as a standalone application that can be installed in the memory 230 of the mobile terminal 200. More particularly, the memory 230 may include a Java Virtual Machine that provides access to native device functionality, and may allow for development of standalone applications, also referred to as MIDlets. As such, the remote control application 222 may be installed as a standard MIDlet in the memory of the mobile terminal 230. However, in other embodiments, the remote control point application 222 can be implemented/installed in the memory of other non-DLNA compliant devices, such as a non-DLNA complaint PC.

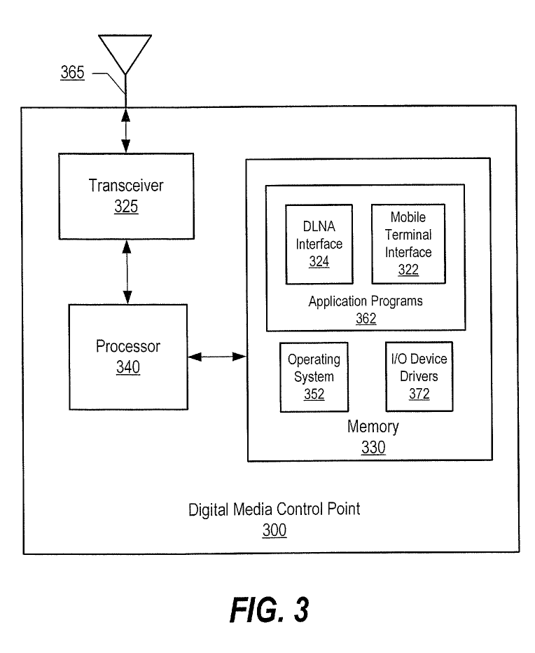

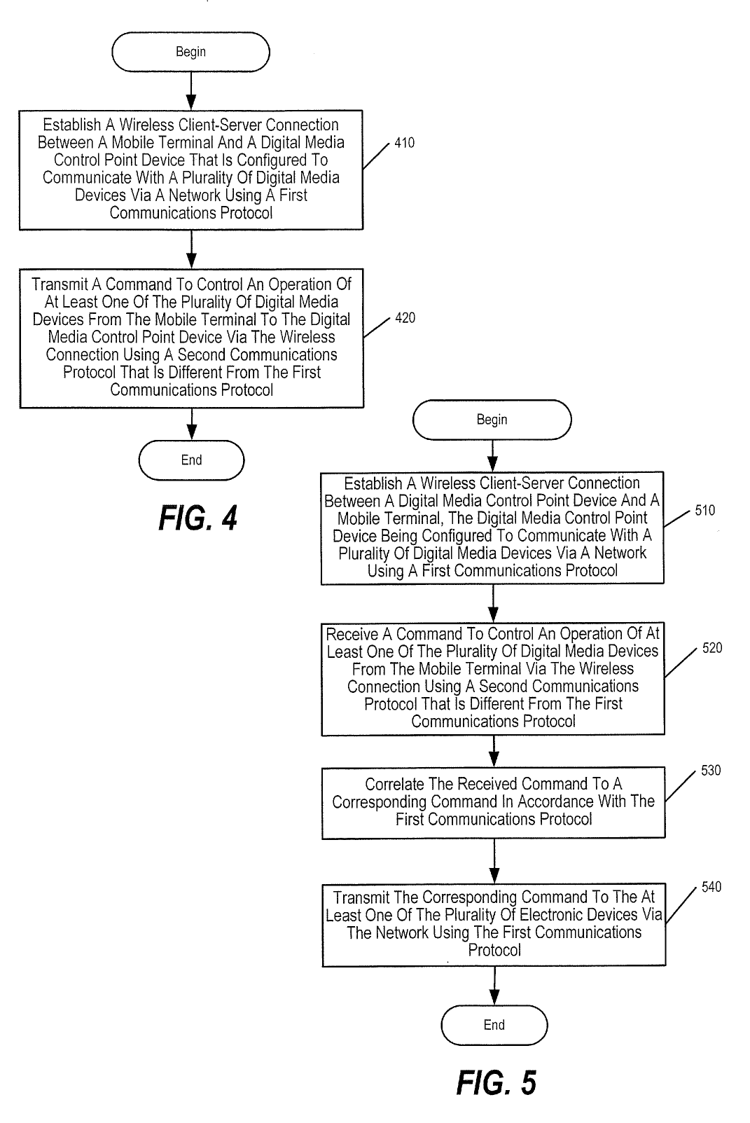

Further operations of the mobile terminal 200 of FIG. 2 will now be discussed with reference to the flowchart of FIG. 4. However, it is to be understood that the example operations illustrated in the flowchart of FIG. 4 may be performed by other components of the mobile terminal in some embodiments. Referring now to FIGS. 2 and 4, the transceiver 225 establishes a wireless connection with a digital media control point device (DMC), such as the DMC 300 of FIG. 3, at block 410. The DMC is configured to communicate with a plurality of digital media devices via a network using a DLNA-compliant communications protocol, such as UPnP. The transceiver 225 may establish wireless communication with the DMC using an API that is based on a different communications protocol than the DLNA-compliant communications protocol used by the DMC to communicate with the other DLNA-compliant digital media devices on the network. For example, the API may be based on a proprietary, non-DLNA compliant application layer communications protocol having a reduced command set in comparison with the DLNA-compliant application layer protocol used by the DMC and the other digital media devices on the network.

Still referring to FIGS. 2 and 4, the controller 240 transmits a command to control operations of one of the digital media devices to the DMC via the wireless connection using the non-DLNA compliant communications protocol at block 420. The command may be a relatively short command used, for example, to find servers and renderers in the network, to select a server for browsing, to browse the selected server, to select a renderer for playback, to control the playback, and/or to configure the playback settings of the renderer. As noted above, the DMC executes the commands from the mobile terminal 200 by transmitting corresponding messages to the digital media devices on the network using the DLNA-compliant protocol. As such, the more extensive and resource-consuming DLNA-compliant protocol is not implemented on the mobile terminal 200. The controller 240 also receives a reply from the DMC via the transceiver 225 in accordance with the non-DLNA compliant protocol. In some embodiments, the controller 240 may only receive a reply from the DMC in response to transmitting the command thereto at block 420, rather than periodically and/or intermittently. As such, power consumption of the mobile terminal 200 may be reduced.

Although FIG. 2 illustrates an exemplary mobile terminal 200 configured to control operations of digital media devices on a network, it will be understood that the present invention is not limited to such a configuration. For example, although the memory 230 is illustrated as separate from the processor 240, the memory 230 or portions thereof may be considered as a part of the processor 240. More generally, while particular functionalities are shown in particular blocks by way of illustration, functionalities of different blocks and/or portions thereof may be combined, divided, and/or eliminated.

FIG. 3 is a block diagram illustrating a digital media control point (DMC) 300 and related methods of operation according to some embodiments of the present invention. In some embodiments, the DMC 300 may correspond to the DMC 150 of FIG. 1. However, in other embodiments, the DMC 300 may be implemented in another network device, such as a PC, router, and/or access point, DMS and/or DMR. As shown in FIG. 3, the DMC 300 includes a transceiver 325 coupled to an antenna 365, a processor 340, and a memory 330. The transceiver 325 includes a transmitter and a receiver configured to establish and maintain wireless and/or wireline communications with one or more other digital media devices via a network, such as the network 130 of FIG. 1. The transceiver 325 further includes a wireless local area network interface transceiver configured to establish a wireless client-server connection with a mobile terminal, such as the mobile terminal 125 of FIG. 1, via the antenna 365. For example, the transceiver 325 may be configured to establish an ad hoc wireless data connection with the mobile terminal according to a localized wireless connection protocol, such as a Bluetooth, Wi-Fi, and/or IR connection protocol. However, the transceiver 325 may also be configured to establish a wireless client-server connection with a digital media device over a network, such as the network 130 of FIG. 1, via a router and/or access point in some embodiments.

The processor 340 is coupled to the transceiver 325 and the memory 330. The processor 340 may be, for example, a commercially available or custom microprocessor that is configured to coordinate and manage operations of the transceiver 325 and/or the memory 330. The memory 330 may represent a hierarchy of memory that may include volatile and/or nonvolatile memory, such as removable flash, magnetic, and/or optical rewritable nonvolatile memory. The memory 330 may be configured to store several categories of software, such as an operating system 352, applications programs 362, and input/output (I/O) device drivers 372. The operating system 352 controls the management and/or operation of the resources of the DMC 300 and may coordinate execution of programs by the processor 340. The I/O device drivers 372 typically include software routines accessed through the operating system 352 by the application programs 362 to communicate with input/output devices. The application programs 362 are illustrative of programs that implement various features according to embodiments of the present invention.

Still referring to FIG. 3, the DMC 300 is a DLNA-compliant device that is configured to communicate with other digital media devices, such as the DMS 160 and/or the DMR 170 of FIG. 1, via a network using a DLNA-compliant communications protocol. As noted above, the DMC 300 is also configured to communicate with a non-DLNA-compliant mobile terminal, such as the mobile terminal 200 of FIG. 2, via a wireless connection. As such, the application programs 362 include both a DLNA interface 324 and a mobile terminal interface 322, which may be configured for communication using different protocols corresponding to the same OSI layer. The DLNA interface 324 is configured to provide communication between the DMC 300 and other networked DLNA-compliant digital media devices using a DLNA-compliant communications protocol. The mobile terminal interface 322 includes an application program interface (API) configured to provide communication between the DLNA interface 324 of the DMC 300 and a remote control point application executing on the mobile terminal, such as the remote control point application 222 stored in the memory 230 of the mobile terminal 200 of FIG. 2. In particular, the mobile terminal interface 322 is used to establish the wireless connection with the mobile terminal via the transceiver 325, and is configured to receive commands specified by the API from the mobile terminal in accordance with a non-DLNA-compliant application layer communications protocol. The mobile terminal interface 322 is further configured to generate corresponding commands in accordance with a DLNA-compliant application layer communications protocol, and provides the corresponding commands to the DLNA interface 324 for communication with other DLNA-compliant digital media devices on the network. The responses from the digital media devices (data, status etc) on the network are similarly received by the DLNA interface 324 using the DLNA-compliant application layer communications protocol and provided to the mobile terminal interface 322, which correlates and forwards the data to the mobile terminal using the non-DLNA-compliant application layer communications protocol.

The API is based on a different communications protocol than those specified by the DLNA standard. For example, the API may be a socket-based, command-driven interface that is based on a proprietary communications protocol having a reduced set of commands in comparison with DLNA-compliant protocols corresponding to the same layer of the OSI model. The reduced set of commands may include short commands to find servers and/or renderers in the network, to select and browse the available media content of a particular server, to select a renderer for playback, and/or to control the playback by the renderer. Such short commands may include, for example, play, stop, pause, rewind, fast forward, skip forward, skip backward, set volume commands, get current DMR status, get events (from the current selected DMS and/or DMR), ask if DMR can play specific content, configure DMR (e.g., resolution, audio quality, equalizer mode, etc.), and/or other short commands. As such, the mobile terminal interface 322 of the DMC 300 may receive commands from the mobile terminal in accordance with the non-DLNA compliant protocol, and the processor 340 may execute the received commands at the DMC 300. The conversion from the proprietary API to the DLNA-compliant protocol is performed by the mobile terminal interface 322 at the same OSI level or layer as the DLNA stack. Thus, the more resource-intensive DLNA-compliant protocols are not implemented on the mobile terminal.

Further operations of the DMC 300 of FIG. 3 will now be discussed with reference to the flowchart of FIG. 5. However, it is to be understood that the example operations illustrated in the flowchart of FIG. 5 may be performed by other network devices that incorporate DMC functionality in some embodiments. Referring now to FIGS. 3 and 5, the transceiver 325 establishes a wireless client-server connection between the DMC 300 and a mobile terminal, such as the mobile terminal 200 of FIG. 2, at block 510. As noted above, the DMC 300 is configured to communicate with a plurality of digital media devices via a network using a DLNA-compliant communications protocol, such as UPnP. However, as the mobile terminal is a non-DLNA compliant device, the transceiver 325 may establish the wireless connection with the mobile terminal using an API based on a different communications protocol. For example, the API may be based on a proprietary, non-DLNA compliant communications protocol having a reduced command set in comparison with the DLNA-compliant protocols corresponding to the same OSI layer, as discussed above.

Still referring to FIGS. 3 and 5, the processor 340 receives a command to control operations of one or more digital media devices on the network from the mobile terminal via the transceiver 325 using the non-DLNA-compliant protocol at block 520. The processor 340 correlates the received command to a corresponding command in accordance with the DLNA-compliant protocol used to communicate with the digital media devices on the network at block 530, and transmits the corresponding command to the specified digital media device on the network at block 540. More particularly, the mobile terminal interface 322 generates a DLNA-compliant command corresponding to the received non-DLNA-compliant command, and the DLNA interface 324 provides this command to the specified digital media device. The processor 340 may further receive data from the specified digital media device using the DLNA-compliant protocol, and may transmit the data and/or a portion thereof to the mobile terminal via the transceiver 325 using the non-DLNA compliant protocol.

Although FIG. 3 illustrates an exemplary digital media control point for controlling operations of digital media devices on a network, it will be understood that the present invention is not limited to such a configuration. For example, although the memory 330 is illustrated as separate from the processor 340, the memory 330 or portions thereof may be considered as a part of the processor 340. Furthermore, while a single transceiver 325 is shown in FIG. 3 by way of illustration, it is to be understood that separate transceivers may be provided; one for communication with the mobile terminal via the wireless connection using the non-DLNA compliant protocol, and another for communication with the digital media devices via the network using the DLNA compliant protocol. Also, while illustrated in FIG. 3 as a stand-alone device, the DMC 300 may be implemented in another network device, such as a PC, router, and/or access point, DMS and/or DMR. More generally, while particular functionalities are shown in particular blocks by way of illustration, functionalities of different blocks and/or portions thereof may be combined, divided, and/or eliminated.

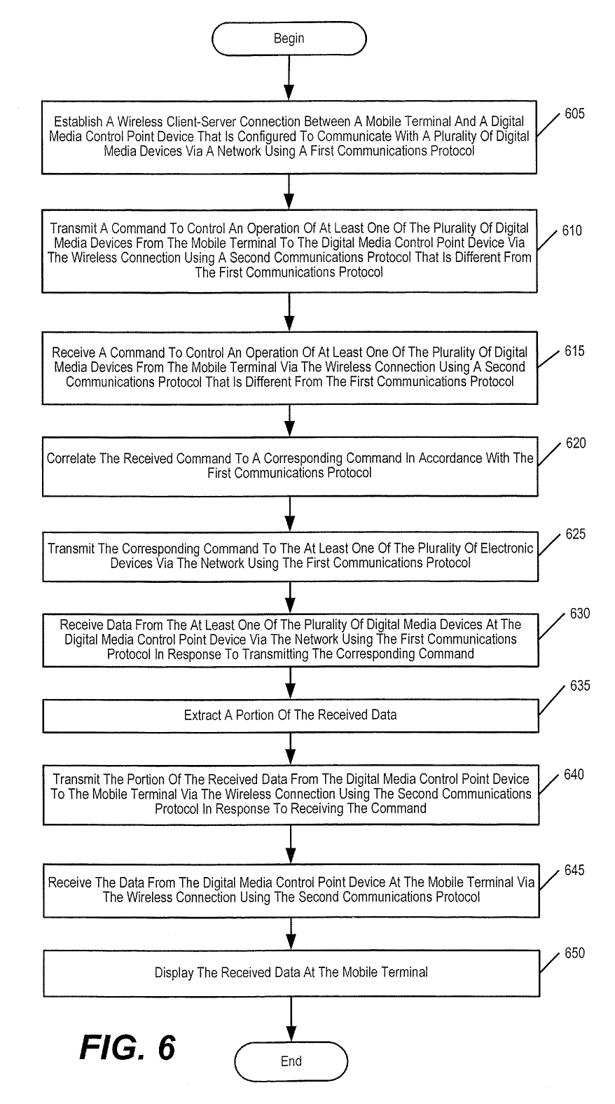

FIG. 6 is a flowchart illustrating example operations for controlling digital media devices on a network using a mobile terminal according to some embodiments of the present invention. Referring now to FIG. 6, a wireless client-server connection is established between a mobile terminal and a digital media control point device (DMC) at block 605. The DMC is a DLNA-compliant device that is configured to communicate with a plurality of DLNA compliant digital media devices on a network using a DLNA-compliant communications protocol, such as UPnP. At block 610, a command to control operations of one of the digital media devices is transmitted from the mobile terminal to the DMC via the wireless connection using a non-DLNA-compliant communications protocol, such as a proprietary communications protocol. For example, the command from the mobile terminal may be a request to a digital media server (DMS) to browse available media content stored therein. Alternatively, the command from the mobile terminal may be a request to a digital media renderer (DMR) to play selected media content.

The command from the mobile terminal is received at the DMC via the wireless connection using the non-DLNA compliant protocol at block 615. The received command is correlated to a corresponding command in accordance with a DLNA compliant protocol at block 620, and is transmitted to one or more specified digital media devices via the network using the DLNA compliant protocol at block 625. In some embodiments, the DMC may include a proprietary application program interface (API) that provides communication between the non-DLNA compliant mobile terminal and the DLNA compliant DMC. For example, where the command from the mobile terminal is a request to browse available media content, the corresponding DLNA-compliant command is transmitted from the DMC to one or more digital media servers via the network using the DLNA compliant protocol. Alternatively, where the command from the mobile terminal specifies playback of selected media content, a corresponding DLNA compliant command is transmitted from the DMC to a DMR via the network using the DLNA compliant protocol, and the DMR fetches the selected media content from a specified DMS for playback on an output device connected to the DMR. As such, execution of the command from the mobile terminal is performed at the DMC, as the mobile terminal does not implement the more comprehensive DLNA compliant protocol.

In response to transmitting the corresponding DLNA compliant command, data from the specified digital media device(s) is received at the DMC via the network using the DLNA compliant protocol at block 630. For example, where the original command from the mobile terminal was a request to browse available media content stored on a specified DMS, a list of available songs and/or movies stored at the specified DMS may be received from the DMS at the DMC. Alternatively, where the original command from the mobile terminal was a request to playback specified media content, a confirmation of the playback may be received from the specified DMR at the DMC. At block 635, a portion of the received data from the specified digital media device(s) may be extracted by the DMC, and the extracted portion of the received data may be transmitted to the mobile terminal via the wireless connection using the non-DLNA compliant protocol at block 640. For example, where the received data from a DMS includes a list of available songs and/or movies stored at the DMS, the DMC may extract metadata representing the available songs and/or movies, and may transmit only the metadata to the mobile terminal. Accordingly, only needed data may be transmitted to the mobile terminal, in accordance with the memory, battery power, and/or processor limitations of the mobile terminal. The portion of the received data is transmitted from the DMC to the mobile terminal at block 640 in response to the command received from the mobile terminal at block 615. As such, battery life of the mobile terminal may be conserved, as responses from the DMC may be received only in response to transmitting a command from the mobile terminal at block 610.

The data from the DMC is received at the mobile terminal at block 645, and is displayed via a display of the mobile terminal at block 650. For example, where the original command from the mobile terminal at block 610 was a request to browse available media content on a particular DMS, metadata representing the available media content on the specified DMS is received from the DMC at block 645 and is displayed on the mobile terminal at block 650. Alternatively, where the original command from the mobile terminal was a request to play specified media content, data indicating confirmation of the requested playback is received from the DMC at block 645, and feedback indicating successful execution of the command is displayed at block 650. Additional data may also be displayed, if requested. Thus, a non-DLNA compliant mobile terminal may be used to control a number of DLNA compliant digital media devices by transmitting commands to a DMC connected to the DLNA compliant digital media devices via a network.

Accordingly, some embodiments of the present invention may allow a mobile terminal with limited functionality, such as a mobile phone, to control multiple digital media devices on a network via a digital media control point (DMC). The mobile terminal does not implement full DMC functionality, but rather, includes a relatively small Remote Control Point application that governs the socket API and the user interface. In other words, the DMC software stack is not implemented on the mobile terminal, which may save development resources.

Thus, some embodiments of the present invention may offer several advantages in comparison to existing technologies, since the Remote Control Point application may be more resource-efficient as compared to implementing the full DMC on the mobile terminal. For example, the power consumption of a mobile terminal implementing the Remote Control Point application may be reduced as compared to implementing full DMC functionality on the mobile terminal, which may be especially important due to the limitations of conventional batteries for mobile devices. Also, requirements on the mobile terminal processor may also be reduced, since the Remote Control Point application generates relatively little network traffic by communicating only short commands to a host DMC that aggregates the network information. Likewise, short replies are delivered from the DMC to the Remote Control Point application. This may require less bandwidth on the network interface, which may allow for other concurrent network applications (e.g. streaming of media to/from the limited device). Shorter response times may also be achieved by allowing the host DMC to aggregate all information and only forward useful data to the mobile terminal. The memory consumption (RAM and/or Flash) of the mobile terminal in some embodiments of the present invention may also be reduced in comparison to implementing a full DMC on the mobile terminal. Moreover, control of the digital media devices on the network using the Remote Control application according to some embodiments of the present invention is transparent to a user of the mobile terminal, i.e. the user experiences little to no difference in controlling the digital media devices, since all functionality is available via the host DMC. Thus, any mobile terminal, such as a mobile phone, can become a Remote Control Point by installing a standalone Remote Control Point application (e.g. a MIDlet), which also allows for backwards compatibility for existing mobile terminals.

The flowcharts of FIGS. 4 to 6 illustrate the architecture, functionality, and operations of embodiments of hardware and/or software for controlling operations of digital media devices using a mobile terminal in accordance with various embodiments of the present invention. It will be understood that each block of the flowchart and/or block diagram illustrations, and combinations of blocks in the flowchart and/or block diagram illustrations, may be implemented by computer program instructions and/or hardware operations. In this regard, each block represents a module, segment, or portion of code, which comprises one or more executable instructions for implementing the specified logical function(s). It should be noted that, in other implementations, the function(s) noted in the blocks may occur out of the order noted in FIGS. 4 to 6. For example, two blocks shown in succession may, in fact, be executed substantially concurrently or the blocks may sometimes be executed in the reverse order, depending on the functionality involved. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

1. A method of controlling operations of a plurality of digital media devices on a network that are configured to communicate using a first communications protocol, the method comprising:
establishing a wireless connection between a mobile terminal and a digital media control point device that is configured to communicate with the plurality of digital media devices via the network using the first communications protocol; and
transmitting a command to control an operation of at least one of the plurality of digital media devices from the mobile terminal to the digital media control point device via the wireless connection using a second communications protocol that is different from the first communications protocol.

2. The method of claim 1, wherein the mobile terminal is not configured for communication using the first communications protocol.

3. The method of claim 1, wherein the first and second communications protocols correspond to a same layer of an Open Systems Interconnection (OSI) model, and wherein the second communications protocol comprises a reduced set of commands in comparison to that of the first communications protocol.

4. The method of claim 3, wherein transmitting the command comprises:
transmitting the command to the digital media control point using an application program interface (API) based on the second communications protocol, wherein the second communications protocol comprises commands that correlate to commands defined by the first communications protocol.

5. The method of claim 4, wherein the first communications protocol comprises a Digital Living Network Alliance (DLNA)-compliant application layer protocol, and wherein the second communications protocol comprises a non-DLNA-compliant application layer protocol.

6. The method of claim 1, further comprising:
receiving, at the mobile terminal, data from the digital media control point device via the wireless connection using the second communications protocol in response to transmitting the command.

7. The method of claim 1, further comprising:
receiving, at the digital media control point device, the command from the mobile terminal via the wireless connection using the second communications protocol;
correlating the received command to a corresponding command in accordance with the first communications protocol; and
transmitting the corresponding command to the at least one of the plurality of digital media devices via the network using the first communications protocol.

8. The method of claim 7, further comprising:
receiving, at the digital media control point device, data from the at least one of the plurality of digital media devices via the network using the first communications protocol in response to transmitting the corresponding command;
extracting a portion of the received data; and
transmitting the portion of the received data from the digital media control point device to the mobile terminal via the wireless connection using the second communications protocol in response to receiving the command.

9. The method of claim 1, wherein the plurality of digital media devices comprises at least one digital media server (DMS) configured to store digital media content and/or at least one digital media renderer (DMR) configured to render the digital media content on an output device.

10. A method for controlling operations of a plurality of digital media devices on a network that are configured to communicate using a first communications protocol, the method comprising:
establishing a wireless connection between a digital media control point device and a mobile terminal, the digital media control point device being configured to communicate with the plurality of digital media devices via the network using the first communications protocol;
receiving, at the digital media control point device, a command to control an operation of at least one of the plurality of digital media devices from the mobile terminal via the wireless connection using a second communications protocol that is different from the first communications protocol;
correlating the received command to a corresponding command in accordance with the first communications protocol; and
transmitting the corresponding command to the at least one of the plurality of digital media devices via the network using the first communications protocol.

11. The method of claim 10, wherein the first and second communications protocols correspond to a same layer of an Open Systems Interconnection (OSI) model, and wherein the second communications protocol comprises a reduced set of commands in comparison to that of the first communications protocol.

12. The method of claim 11, wherein receiving the command comprises:
receiving the command from the mobile terminal using an application program interface (API) based on the second communications protocol, wherein the second communications protocol comprises commands that correlate to commands defined by the first communications protocol.

13. The method of claim 11, wherein the first communications protocol comprises a Digital Living Network Alliance (DLNA)-compliant application layer protocol, and wherein the second communications protocol comprises a non-DLNA-compliant application layer protocol.

14. The method of claim 11, further comprising:
receiving, at the digital media control point device, data from the at least one of the plurality of digital media devices via the network using the first communications protocol in response to transmitting the corresponding command;
extracting a portion of the received data; and
transmitting the portion of the received data from the digital media control point device to the mobile terminal via the wireless connection using the second communications protocol in response to receiving the command.

15. The method of claim 11, wherein the plurality of digital media devices comprises at least one digital media server (DMS) configured to store digital media content and/or at least one digital media renderer (DMR) configured to render the digital media content on an output device.

16. A mobile terminal, comprising:
a wireless transceiver configured to establish a wireless connection with a digital media control point device that is configured to communicate with a plurality of digital media devices via a network using a first communications protocol; and
a controller configured to transmit a command to control an operation of at least one of the plurality of digital media devices to the digital media control point device via the wireless connection using a second communications protocol that is different from the first communications protocol.

17. The mobile terminal of claim 16, wherein the mobile terminal is not configured for communication using the first communications protocol.

18. The mobile terminal of claim 16, wherein the first and second communications protocols correspond to a same layer of an Open Systems Interconnection (OSI) model, and wherein the second communications protocol comprises a reduced set of commands in comparison to that of the first communications protocol.

19. The mobile terminal of claim 18, wherein the controller is configured to transmit the command using a proprietary application program interface (API) based on the second communications protocol, wherein the second communications protocol comprises commands that correlate to commands defined by the first communications protocol.

20. The mobile terminal of claim 18, wherein the first communications protocol comprises a Digital Living Network Alliance (DLNA)-compliant application layer protocol, and wherein the second communications protocol comprises a non-DLNA-compliant application layer protocol.

21.-40. (canceled)
